(19) United States
(12) Patent Application Publication
(10) Pub. No.: US 2003/0066338 A1
(43) Pub. Date: Apr. 10, 2003

(54) Apparatus for testing prosthetic heart valves, and methods of using same

(76) Inventors: Douglas L. Michalsky, Austin, TX (US); Phillip Edwin Carr, Austin, TX (US); Edwin Lee Hankinson, Georgetown, TX (US)

Correspondence Address: SULZER MEDICA USA INC., Suite 1600, 3 East Greenway Plaza, Houston, TX, 77046, US

(21) Appl. No.: 09/973,580

(22) Filed: Oct. 9, 2001

(51) Int. Cl. G01N 19/00; G01M 3/02

(52) U.S. Cl. 73/37; 73/865.9

(57) ABSTRACT

A prosthetic heart valve testing apparatus is disclosed. The apparatus comprises a test chamber, a slide plate slidingly and sealingly coupled to the test chamber, the slide plate having an opening formed therein that is adapted to receive a prosthetic heart valve to be tested in the test chamber, a storage member containing a plurality of prosthetic heart valves to be tested in the test chamber, and a load/unload means for transferring at least one of the heart valves in the storage member between the storage member and the slide plate. A method disclosed herein comprises positioning the storage member in a first position, moving a first heart valve from the storage member in the first position to the test chamber, performing at least one test on the first heart valve in the test chamber, and returning the first heart valve from the test chamber to the storage member. The method further comprises moving the storage member to a second position to position a second of the plurality of heart valves for removal from the storage member, moving the second heart valve from the storage member to the test chamber, performing at least one test on the second heart valve in the test chamber, and returning the second heart valve to the storage member.

### BACKGROUND OF THE INVENTION

1. Field of the Invention

This invention relates generally to prosthetic heart valves and testing thereof, and, more particularly, to an apparatus for testing prosthetic heart valves, and methods of using same.

2. Description of the Related Art

Various types of heart valve prostheses have been proposed, and many give generally satisfactory operation. One such heart valve is described, for example in U.S. Pat. No. 5,147,390 (the '390 patent) to Campbell, which patent is assigned to Sulzer Carbomedics Inc., the predecessor of the assignee of the present invention. FIG. 1 illustrates the various parts of an illustrative prior art prosthetic heart valve, generally designated 10. The prosthetic heart valve 10 includes a generally annular valve body 12. Disposed within the valve body 12 are a pair of occluders or leaflets 18, 20. The leaflets 18, 20 are mounted for both pivoting and translational movement between open and closed positions. The prosthetic heart valve 10 also has a diameter, indicated by line 10a. The prosthetic heart valve 10 has an inflow side 10b and an outflow side 10c. One leaflet 20 is shown in partial cut-away to reveal a pivot recess 22. Two recesses are provided for each leaflet 18, 20, i.e., one on each side of the valve body 12. Each leaflet has a pivot (not shown) that is positioned in its adjacent recess 22. For further explanation of the operation of the heart valve, the reader is referred to the '390 patent. Further detailed explanation, however, is not necessary for the understanding of the present invention. To install a prosthetic heart valve 10 in a patient, a stiffening ring (not shown) and sewing ring (not shown) are usually added to the annular valve body 12. However, testing of the prosthetic heart valve 10 preferably occurs prior to adding the stiffening ring and sewing ring.

A prosthetic or mechanical heart valve, such as that described in the '390 patent, can be expected to open and close a great number of times during its use. It is desirable to minimize, insofar as possible, the number of failures experienced in the use of a prosthetic heart valve. Testing to insure functional integrity of a heart valve 10 is therefore an important part of prosthetic heart valve development and manufacture. Heart valve function testers are known which open and close the mechanical heart valve thereby mimicking the action of the heart. Fluid is forced past the prosthetic heart valve 10 to open the valve. An existing back pressure is then allowed to close the prosthetic heart valve 10 when the pulsatile forward pressure is removed.

However, additional testing is generally performed to test for additional defects. For example, minute cracks or other surface defects in the pivots of the leaflets 18, 20 or in pivot recesses 22 of the valve body 12 are difficult to detect. It is known, however, from the application of fracture mechanics, that cracks below a certain maximum size will not cause failure. Cracks or other surface defects larger than the maximum allowable size can be detected by performing a proof test on the prosthetic heart valve 10 and its various components. In some embodiments, the load (or pressure) during such a proof test is some multiple of the pressure the prosthetic heart valve 10 is expected to experience when implanted in a patient. The proof test is performed at this higher pressure to, among other things, provide a factor of safety associated with the valve 10. The primary purpose of proof testing is to insure that the prosthetic heart valve 10 and its various components can withstand the forces it will experience when implanted in a patient.

One illustrative apparatus for testing of prosthetic heart valves 10 is depicted in U.S. Pat. No. 5,531,094, which is assigned to Sulzer Carbomedics Inc., the predecessor of the assignee of the present invention. However, among other things, the testing apparatus disclosed in that patent requires operators to manually load prosthetic heart valves 10 in the test chamber of the apparatus one at a time. Such a process is very labor-intensive, time-consuming and expensive. Moreover, the catch tank 40 of the apparatus disclosed in U.S. Pat. No. 5,531,094 is not provided with a means to control the level of test fluid in the catch tank 40. Accordingly, the pressure applied on the outflow side 10c of the prosthetic heart valve 10, i.e., a pressure that is analogous to, for example, the aortic pressure, experiences undesirable variations due to changes in the level of the test fluid in the catch tank 40. Additionally, in the apparatus disclosed in U.S. Pat. No. 5,531,094, the test fluid pressure on the inflow 10b and outflow 10c sides of the heart valve 10 being tested is monitored using individual gage (relative to atmospheric) pressure sensors. Accordingly, calculating the differential pressure across the heart valve 10 based upon these two separate readings leads, at least in some cases, to errors due to subtracting individually sensed readings from the individual pressure sensors.

The present invention is directed to overcoming, or at least reducing the effects of, one or more of the problems described above.

### SUMMARY OF THE INVENTION

The present invention is generally directed to an apparatus for testing prosthetic heart valves, and methods of using same. In one illustrative embodiment, the apparatus is comprised of a test chamber, a slide plate slidingly and sealingly coupled to the test chamber, the slide plate having an opening formed therein that is adapted to receive a prosthetic heart valve to be tested in the test chamber, a storage member containing a plurality of prosthetic heart valves to be tested in the test chamber, and a load/unload means for transferring at least one of the heart valves in the storage member between the storage member and the slide plate. In further embodiments, the load/unload means is comprised of first and second pneumatic cylinders that are adapted, when actuated, to remove a heart valve from the storage member and position it in the slide plate. In further embodiments, a third pneumatic cylinder is coupled to the slide plate. When actuated, the third cylinder moves the slide plate relative to the test chamber to thereby position a valve in the chamber for subsequent testing.

In one illustrative embodiment, a method of testing prosthetic heart valves is disclosed herein that comprises providing a prosthetic heart valve testing apparatus, the apparatus comprised of a test chamber and a storage member, the storage member having a plurality of prosthetic heart valves stored therein, positioning the storage member in a first position, moving a first heart valve from the storage member in the first position to the test chamber, performing at least one test on the first heart valve in the test chamber, and returning the first heart valve from the test chamber to the storage member. The method further comprises moving the storage member to a second position to position a second of the plurality of heart valves for removal from the storage member, moving the second heart valve from the storage member to the test chamber, performing at least one test on the second heart valve in the test chamber, and returning the second heart valve to the storage member.

### BRIEF DESCRIPTION OF THE DRAWINGS

The invention may be understood by reference to the following description taken in conjunction with the accompanying drawings, in which like reference numerals identify like elements, and in which:

FIG. 1 is a perspective view of an illustrative prior art prosthetic heart valve that may be tested in the present invention;

FIG. 2 is a schematic depiction of a testing apparatus and various supporting utilities in accordance with one illustrative embodiment of the present invention;

FIGS. 3A-3I are various views of various components of one illustrative embodiment of a testing apparatus of the present invention; and

FIG. 4 is a functional block diagram depicting various functional aspects of the computer system of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. The relative sizes of the various features and structures depicted in the drawings may be exaggerated or reduced as compared to the size of those features or structures on real-world devices. Moreover, for purposes of clarity, the devices depicted herein do not include all of the detailed components of a real-world device. Nevertheless, the attached drawings are included to describe and explain illustrative examples of the present invention. Additionally, U.S. Pat. No. 5,531,094 is hereby incorporated by reference in its entirety.

In general, the present invention is directed to an apparatus for testing prosthetic heart valves, and various methods of using same. As will be readily apparent to those skilled in the art upon a complete reading of the present application, the present invention is applicable to the testing of a variety of prosthetic heart valves. Thus, the particular type of prosthetic heart valve described and discussed herein should not be considered a limitation of the present invention unless such limitations are clearly set forth in the appended claims.

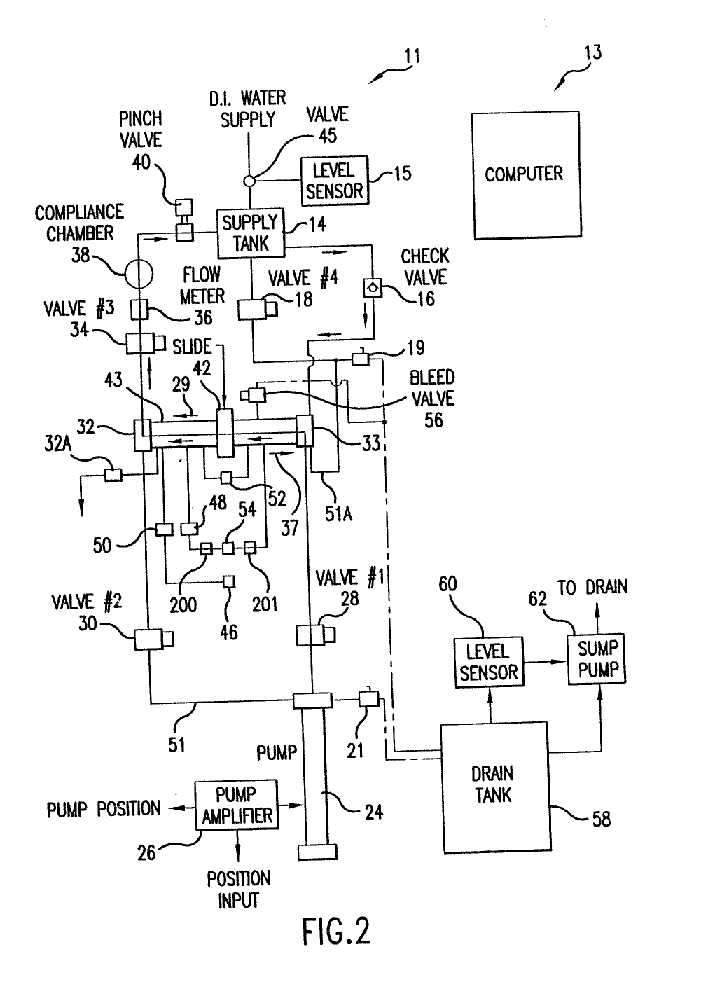

FIG. 2 schematically depicts one illustrative embodiment of a prosthetic heart valve testing apparatus 11 of the present invention. As shown therein, the testing apparatus 11 is comprised of a supply tank 14, a test chamber 43 with end caps 32, 33, a pump 24, a drain tank 58, and a computer 13. The apparatus 11 further comprises a plurality of ball valves 18, 28, 30, 34, a plurality of pressure sensors 46, 52, 54, DC solenoid isolation valves 48, 50, a plurality of manual drain valves 19, 21, a plurality of level sensors 15, 60, a check valve 16, a bleed valve 56, a solenoid valve 45, a flow meter 36, a compliance chamber 38, a pinch valve 40, a pump amplifier 26, and a sump pump 62. The apparatus 11 further comprises a slide plate 42 that will be used to position and hold a prosthetic heart valve (not shown in FIG. 2) that is to be tested in the test chamber 43. The apparatus 11 may also have a relief valve 32A such as a Swagelock SS-4CP4-25 coupled to the test chamber 43 to prevent exceeding maximum proof test pressure. The apparatus 11 further comprises a plurality of lines 51 that are used to interconnect the various components of the apparatus 11. The lines 51 may vary in size and may be comprised of a variety of materials, e.g., polyurethane, stainless steel, etc. Additionally, the inventors have found that it may be advantageous to position the sensors 52, 54 and 46 as close as possible to the test chamber 42. That is, the lines connecting the pressure sensors 52, 54 and 46 should be as short as is practicable. Moreover, restrictive elements 200, 201, such as needle valves or precision orifices, may be used to dampen natural frequency oscillation in the lines, especially to the more sensitive pressure sensors, e.g., sensor 54.

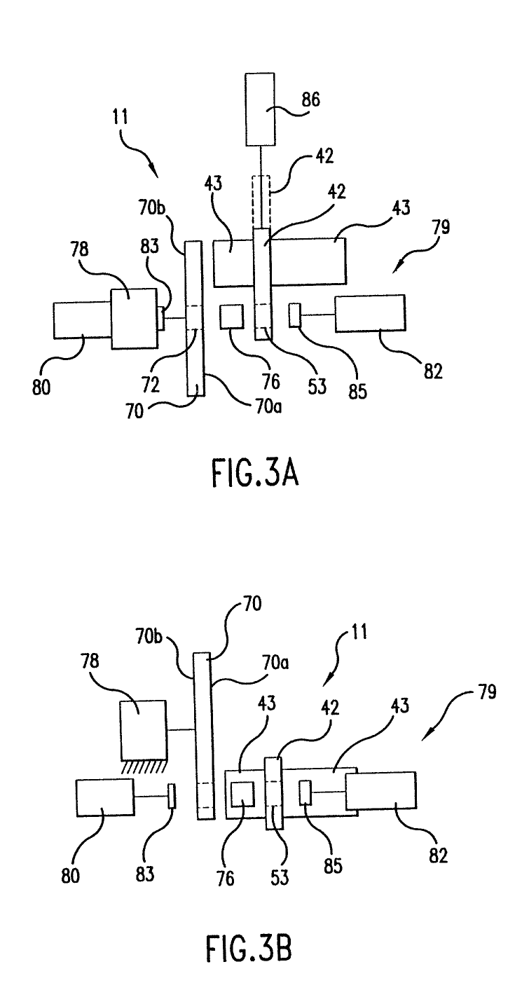

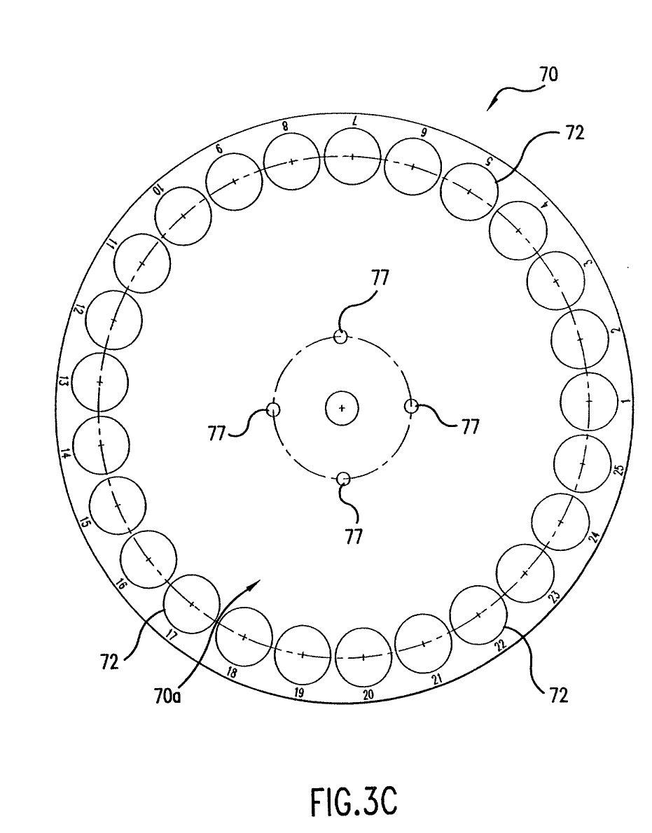

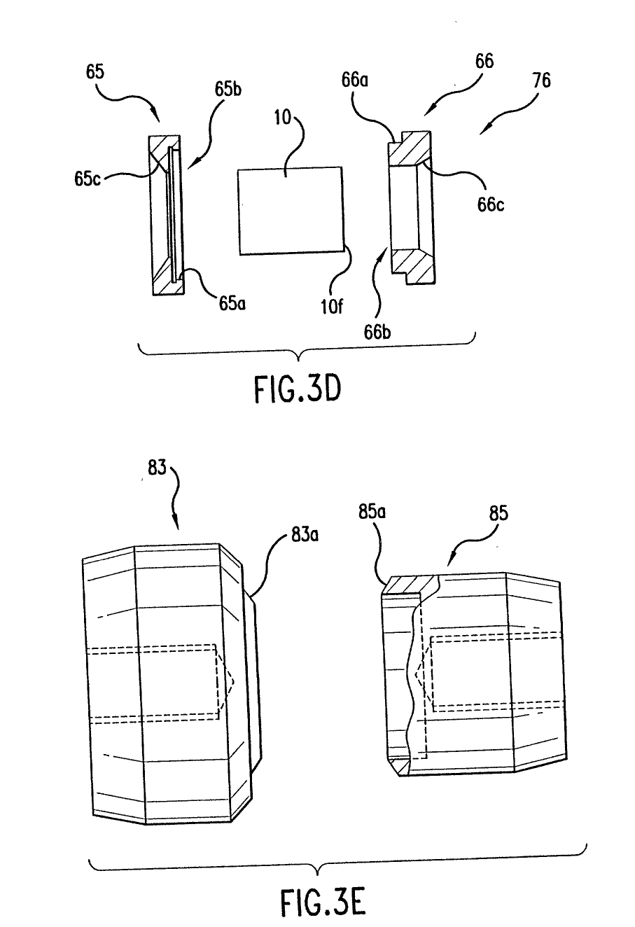

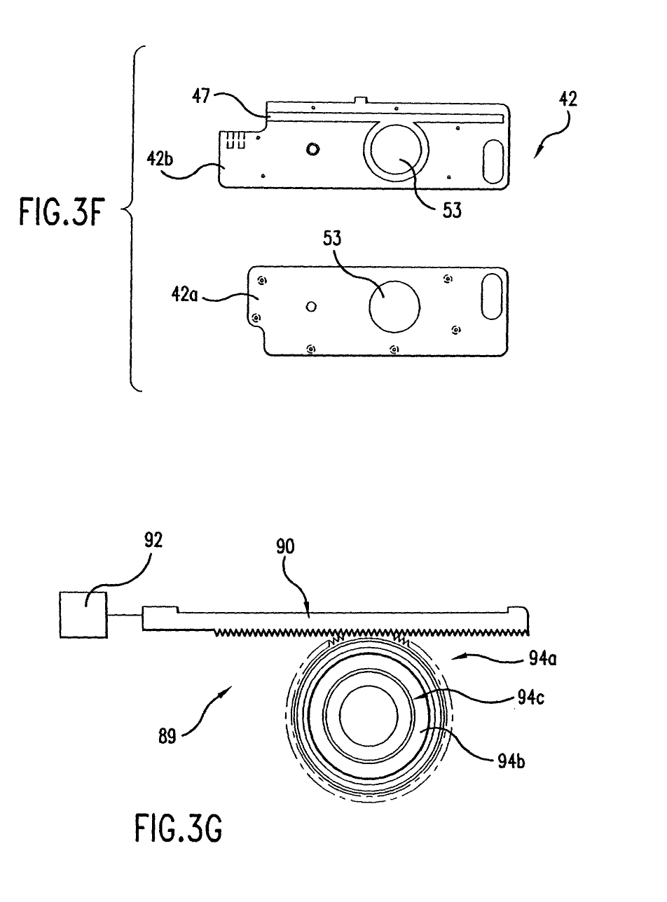

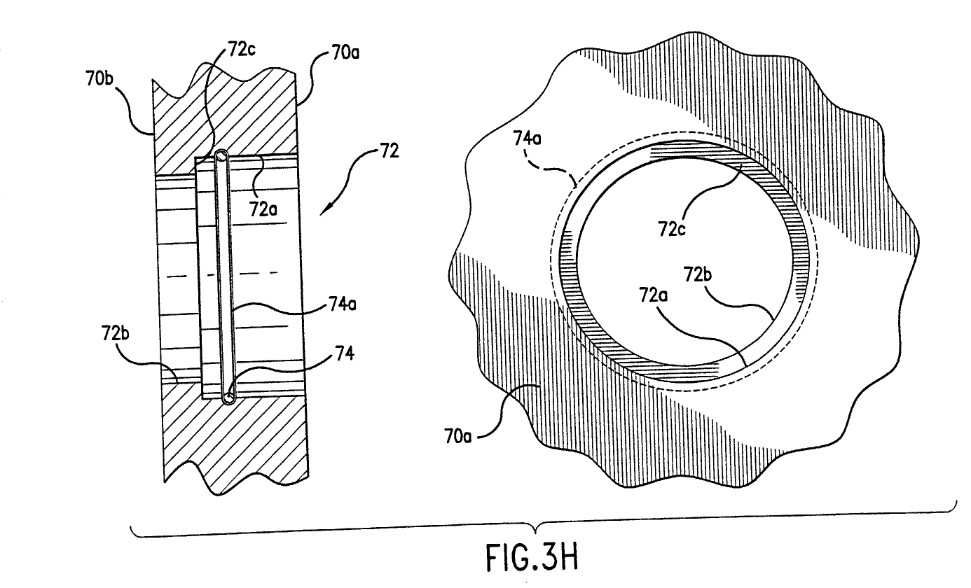

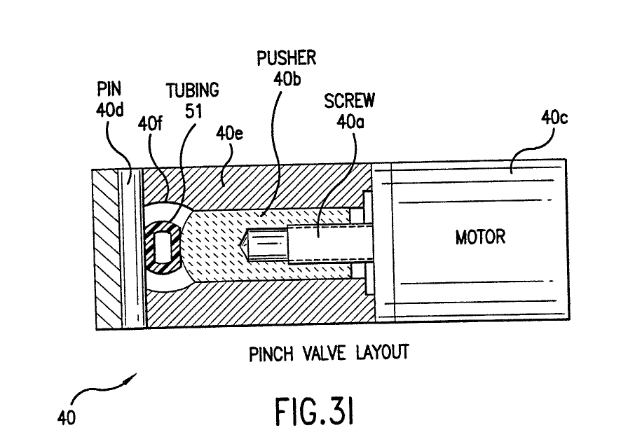

FIGS. 3A-3I schematically depict various components of an illustrative embodiment of the testing apparatus 11 of the present invention. FIGS. 3A and 3B are, respectively, a plan view and side view of the testing apparatus 11. Shown therein are the test chamber 43, the slide plate 42, a pneumatic cylinder 86 coupled to the slide plate 42, a heart valve holder 76, a storage member 70, a stepper motor driven stage 78, and pneumatic cylinders 80, 82 having ends 85, 83, respectively. The slide plate 42 has an opening 53 formed therein for purposes to be described more fully below. An illustrative opening 72 is also depicted in the storage member 70 in FIGS. 3A and 3B. The slide plate 42 is depicted in its load/unload position in FIG. 3A. The dashed lines indicate the test position for the slide plate 42 wherein a heart valve will be positioned within the test chamber 43 for testing, as described more fully below. Although not depicted in the drawings, an O-ring type seal is provided at the surfaces where the slide plate 42 and the test chamber 43 meet. However, it should be understood that the seal established between the slide plate 42 and the test chamber 43 is not absolutely liquid tight. That is, there may be some amount of leakage of test fluid as the slide plate 42 is moved and/or during some of the testing procedures described herein. Nevertheless, the seal achieved is sufficient for conducting the tests described herein.

FIG. 3C depicts an illustrative embodiment of the storage member 70 that is adapted to hold a plurality of prosthetic heart valves (not shown in FIGS. 3A-3C) to be tested in the test apparatus 11. In one illustrative embodiment, the storage member 70 is a disc of material or carousel that is comprised of a plurality of openings 72, each having an O-ring 74 positioned therein. See FIG. 3H. The storage member 70 has surfaces 70a and 70b. See FIGS. 3A-3B. The opening 72 is adapted to have a heart valve holder 76 (containing a heart valve 10) positioned therein. The size of the openings 72 may vary depending upon the size of the valve holder 76 positioned therein. FIG. 3H depicts one illustrative embodiment of an opening 72 in the storage member 70. As shown therein, the opening 72 has a recess 74a formed therein that is adapted to received an O-ring 74. In the disclosed embodiment, the opening 72 is a step-like structure having a shoulder 72c formed therein. As such, the opening 72 may be considered to define two different openings 72a and 72b of differing diameter. In use, the heart valve holder 76 of the present invention is manually inserted into the opening 72a until such time as the O-ring 74 engages the outer surface of the heart valve holder 76. At this time, the heart valve holder 76 will be positioned adjacent the shoulder 72c of the opening 72. The opening 72b is sized such that the end 83 of the cylinder 80 may pass therethrough.

In one illustrative embodiment, each opening 72 has a diameter of approximately 1.52 inches, and the O-ring 74 is a Dash 128 silicone O-ring. In the depicted embodiment, the storage member 70 has 25 openings 72. The storage member 70 is made of an acetyl copolymer material and it has an outer diameter of approximately 17 inches, and a thickness of approximately 1 inch. Also depicted in FIG. 3C are a plurality of openings 77 which will allow the storage member 70 to be coupled to a stepper motor 78 (see FIGS. 3A-3B) that will be used to index or move the storage member 70, thereby positioning a heart valve 10 in the storage member 70 in the proper position such that it may be removed from the storage member 70, tested in the test chamber 43, and returned to the storage member 70. In one illustrative embodiment, a Compumotor Zeta 6108 Indexer/Driver is used to control the stepper motor driver stage 78 to position the storage member 70. After a complete reading of the present application, those skilled in the art will appreciate that the storage member 70 depicted in the attached drawings is illustrative in nature, and that the physical configuration of the storage member 70 may vary. Thus, the particular structural details of the storage member 70 depicted in the drawings should not be considered a limitation of the present invention unless such limitations are clearly set forth in the appended claims.

As shown in FIGS. 3A-3B, the apparatus 11 comprises a load/unload assembly 79 that will be used in transferring heart valves 10 between the storage member 70 and the test chamber 43. In one illustrative embodiment, the load/unload assembly 79 comprises a pair of pneumatic cylinders 80, 82, the slide plate 42, and a pneumatic cylinder 86 that is coupled to the slide plate 42. In general, as described more fully below, the cylinder 86 will be used to move the slide plate 42 to is load/unload position (depicted in FIGS. 3A-3B) wherein a heart valve 10 is transferred between the storage member 70 and the slide plate 42 using the cylinders 80, 82, as described more fully below.

FIG. 3D depicts an exploded view of one illustrative embodiment of the heart valve holder 76 and an illustrative heart valve 10 to be positioned in the heart valve holder 76. The heart valve holder 76 is comprised of first and second portions 65, 66 that are adapted to be threadingly mated together by the engagement of the internal threads 65a on portion 65 and the external threads 66a on portion 66. The portions 65, 66 further comprise valve recesses 65b, 66b that are adapted to receive the heart valve 10 therein. The heart valve holder 76 further comprises sloped surfaces 65c, 66c that are adapted to engage, respectively, sloped surfaces 83a and 85a on the cylinder ends 83, 85 of cylinders 80, 82. See FIG. 3E. The surfaces 85a, 83a may be tapered at an angle of approximately 32-36 degrees. The surfaces 65c, 66c may be tapered at an angle of approximately 46-63 degrees, depending upon the size of the heart valve 10 being tested. To use the heart valve holder 76, the inflow edge 10f of the heart valve 10 is positioned in the recess 66b. Thereafter, the portion 65 is positioned over the valve 10 and threadingly engaged to the portion 66 via the connection of internal threads 65a and external threads 66a. The heart valve holders 76 are manually pushed into the opening 72 in the storage member 70 where they are secured by contact with the O-rings 74 about their diameter.

FIGS. 3F and 3G will be referenced to describe a rotating assembly 89 that may be used to rotate a prosthetic heart valve 10 within the slide plate 42 in the test chamber 43 as part of the testing of the prosthetic heart valve 10 as described more fully below. As shown therein, the slide plate 42 is comprised of first and second portions 42a, 42b that are adapted to be bolted together. When assembled, the slide plate portions 42a, 42b define an opening 53 adapted to have a heart valve holder 76 (not shown in FIG. 3F) containing a heart valve 10 positioned therein. As shown in FIG. 3G, the heart valve holder 76 of the present invention is adapted to be rotated through use of a rack and pinion type mechanism. More particularly, the rotating assembly 89 is comprised of a rack 90 that is coupled to a pneumatic cylinder 92. The rack 90 engages a spur gear 94a coupled to the heart valve holder rotator 94b. A heart valve holder 76, containing heart valve 10, is pushed into the heart valve holder rotator 94b and secured by contact with O-ring 94c. Thus, by actuation of the cylinder 92, the heart valve 10 positioned within the heart valve holder rotator 94b may be rotated. The rack 90 and heart valve holder rotator 94b with attached spur gear 94a is adapted to be positioned in the opening 47 in the portion 42b of the slide plate 42.

The various components of the testing apparatus 11 may be comprised of any of a variety of such components capable of performing the functions described herein. The following are examples of some of the components that may be used with the present invention. For example, the valves 18, 28, 30, 34 may be one-inch pneumatically actuated polypropylene ball valves manufactured by George Fisher, and the flow meter 36 may be a T110R blood flow meter manufactured by Transonic Systems, Inc. The pressure sensors 52, 54, 46 may be Validyne Engineering Corporation P55D differential pressure transmitters. The pressure sensor 52 is sized and selected such that it has a relatively high useful range of approximately ±50 psi. The pressure sensors 54, 46 are sized and selected such that they have a relatively low useful range of approximately ±5 psi (258 mm Hg). The pump 24, including the pump amplifier 26, may be a Vivtro model number SPA5891B reciprocating type pump that is DC servo driven and also includes a tachometer and LVDT feedback. The pneumatic cylinders 80, 82, 86, 92 may be foot-mounted dual action pneumatic cylinders provided by PHD Tom Thumb. Of course, if desired, hydraulic, electric or other cylinders may be used in lieu of pneumatic cylinders. Air may be supplied to drive the various pneumatic components and controls from an air source (not shown) that is commonly available in modern testing facilities or laboratories.

The compliance chamber 38 is comprised of a chamber and two air-filled diaphragms. Water flows between the two diaphragms. One illustrative design suitable for the compliance chamber 38 is described in a dissertation by David W. Wieting entitled “Dynamic Flow Characteristics of Heart Valves” submitted to the University of Texas at Austin in 1969. Alternatively, a design consistent with that disclosed in Rosenberg et al., “Design and Evaluation of the Pennsylvania State University Mock Circulatory System,” Amer. Soc. of Artificial Organs, 4:41-49 (1981), may be employed. In general, as will be described more fully below, the compliance chamber 38 will be used during the functional testing of the heart valve 10 to create a pressure on the outflow side 10c of the heart valve 10 that somewhat replicates the aortic pressure on the outflow side of an aortic heart valve.

The pinch valve 40 may be a lead screw driven clamping device that is used to restrict the flow out of the compliance chamber 38. In one embodiment, as shown in FIG. 31, the pinch valve 40 is comprised of a stepper motor 40c, a housing 40e, a screw 40a, a pusher 40b, and a pin 40d. The pinch valve 40 has an opening 40f formed therein that is adapted to have a portion of a line 51, adapted to have fluid flowing therethrough, positioned in the opening 40f of the pinch valve 40. The pin 40d is used to provide a surface against which the pusher 40b may be urged to allow more complete closing of the line 51. The stepper motor 40c is used to control the pinch valve 40, thereby restricting test fluid flow through the line 51 to develop a pressure, i.e., aortic pressure, on the outflow side 10c of the heart valve 10 during the functional testing of the heart valve 10. In one embodiment, an IM483 Miniature High Performance Microstepper Drive is used to control the pinch valve 40. Limit switches (not shown) at the travel extremes of the stepper motor actuator are used to “home” the pinch valve 40 and to indicate travel limits during operation. The combination of the compliance chamber 38 and the pinch valve 40 serves to simulate the systemic compliance and resistance of the human body for blood exiting the heart into the aorta. The compliance chamber 38 uses air-filled diaphragms in the test fluid flow path to act as an “air-spring,” and the pinch valve 40 restricts the test fluid flow. Simulated compliance is altered by adjusting the air pressure in the diaphragms of the compliance chamber 38. The flow of test fluid through the pinch valve 40 is controlled by actuation of the stepper motor.

The functions of various other components of the test apparatus 11 will now be described. The level sensors 15, 60 are adapted to sense the level of fluid in the supply tank 14 and drain tank 58, respectively. The level sensor 60 also controls the operation of the sump pump 62 to control the level of fluid in the drain tank 58. The valve 45 is used to control the supply of test fluid, e.g., deionized water, to the supply tank 14. The valves 19, 21 are manually controlled valves that may be used in draining the apparatus 11. The bleed valve 56 is used to bleed air from the test chamber 43 as it is being filled with water and after the introduction of air into the system caused by the movement of the slide plate.

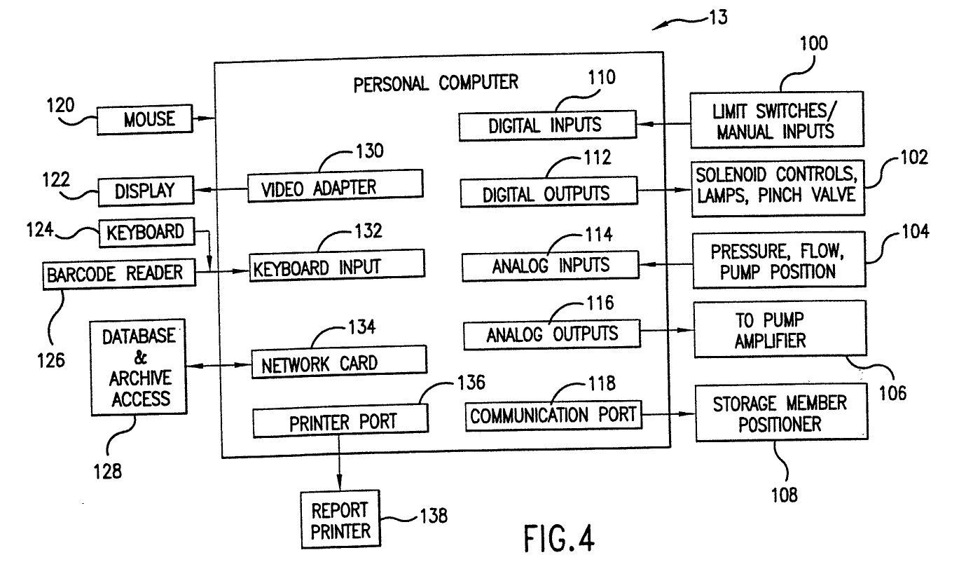

FIG. 4 is a block diagram depicting the variety of inputs that may be provided to the computer 13 of the present invention, and at least some of the outputs provided by the computer 13 in controlling the testing apparatus 11. As shown therein, in one embodiment, the computer 13 is comprised of a mouse 120, a display or monitor 122, a keyboard 124, a barcode reader 126, a database 128, a video adapter 130, a keyboard input 132, a network card 134, and a printer port 136. A printer 138 is coupled to the computer 13. The computer 13 may be any type of computer device useful for executing software instructions. In one illustrative embodiment, the computer 13 is a personal computer.

The computer 13 is adapted to receive a plurality of digital inputs 110 from limit switches, valves, or other manual inputs, as indicated at block 100, and it provides digital outputs 112 to control a variety of valves of the apparatus 11, as indicated at block 102. The computer 13 also receives a plurality of analog inputs, as indicated at block 114, such as those provided from the pressure sensors, flow meter and pump position indicators of the apparatus 11, as indicated at block 104. The computer 13 also provides various analog outputs 116, such as to the pump amplifier, as indicated in block 106. Lastly, the computer 13 provides positioning control of the storage member 70, as indicated at block 108, via communication port 118 of the computer 13.

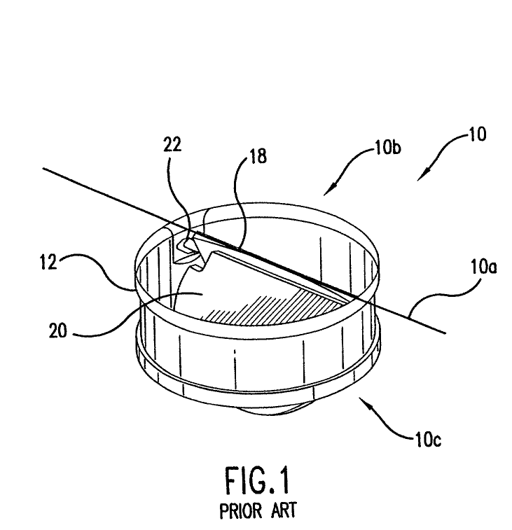

In general, the present invention may be used to perform a proof test and a functional test on a prosthetic heart valve 10. The proof test is used to test the mechanical strength of the connection between the heart valve leaflet pivot (not shown) and the pivot recess 22 in the heart valve 10 in which the heart valve leaflet pivots are positioned. See FIG. 1. The prosthetic heart valve 10 is oriented such that the valve leaflets 18, 20 are oriented in an approximately vertical plane. That is, during the proof test, the valve 10 is oriented such that its diameter 10a is approximately vertical. In this position, the leaflets 18, 20 will tend to fall against one side of the annular body 12. In this condition, the upper pivots will have all of the available play or gap with respect to their associated recesses. This represents the worst case condition for the interaction between the pivots and the recesses 22. Consequently, it is desirable to test the heart valve 10 in a position where the pivots are oriented upwardly and to reverse the heart valve 10 by approximately 180° so that the second set of pivots (not shown) and recesses 22 can also be tested in the worst case condition. Once the valve has been proof tested in both positions, it is declared to have successfully passed the proof test. In general, the proof test is designed such that a required minimum differential pressure is applied across the heart valve 10 without exceeding a selected maximum allowable differential pressure. The target pressure is selected such that it is slightly above the differential pressure desired to be applied to the heart valve 10. In one illustrative embodiment, the required differential pressure is selected to be approximately 22 psi, the target differential pressure is selected to be approximately 25 psi, and a maximum pressure of approximately 30 psi is allowed. Of course, these values may vary depending upon the type and size of the heart valves 10 being tested.

The functional test of the prosthetic heart valve 10 is intended to test the valve 10 under conditions that are at least somewhat representative of the conditions the prosthetic heart valve 10 will experience when implanted in a human patient. In particular, during this process, the functional test will be used to determine parameters such as the mean pressure drop across the heart valve 10 during the period of forward flow of the test fluid through the heart valve 10, and the percent backflow or leakage through the heart valve 10. Additional parameters may also be determined during this functional test, e.g., closing volume, leakage volume, etc. In general, the pump 24 will be driven such that it drives the test fluid in a manner that is similar to blood flow in a human heart. For example, the pump 24 may be driven such that it replicates a heart pumping at approximately 70 beats per minute, and it may pump the water at, for example, a flow rate of approximately 5 l/min. More particularly, the pump 24 pushes test fluid, e.g., water, through the valve 10. The flow rate of the test fluid is monitored by the flow meter 36, and the pressure drop across the heart valve 10 is sensed by the pressure sensor 54. As the pump retracts, the valve leaflets 18, 20 close, and water is pulled back through the check valve 16, which simulates the action of a mitral valve in a human heart. Additional details of the functional test will be described more fully below.

The overall operation of the testing apparatus 11 will now be discussed. Initially, operators manually position a prosthetic heart valve 10 in a heart valve holder 76 and, thereafter, position the heart valve holder 76 into an opening 72 in the storage member 70. This process is repeated until up to twenty-five openings 72 in the storage member 70 contain a heart valve holder 76 having a prosthetic heart valve 10 positioned therein.

The prosthetic heart valves 10 may be removed from the openings 72 in the storage member 70 in accordance with the following technique. The cylinder 86 is actuated to extend the slide plate 42 to its load/unload position, as indicated in FIG. 3A. The slide plate 42 has an opening 53 formed therein that is adapted to receive and hold a heart valve holder 76 containing a prosthetic heart valve 10. Next, the cylinder 82 is actuated thereby extending end 85 through the opening 53 in the slide plate 42. The extension continues until such time as the surface 85a of the end 85 of the cylinder 82 engages the surface 66c of the heart valve holder 76. Then, the cylinder 80 is actuated and its end 83 is extended until such time as the surface 83a of the end 83 engages the surface 65c of the heart valve holder 76. Thereafter, the pressure on the cylinder 82 is reduced thereby allowing cylinder 80 to continue to extend. The further extension of cylinder 80 disengages the heart valve holder 76 from the opening 72 in the storage member 70. The extension of the cylinder 80 continues until such time as the heart valve holder 76 is securely engaged within the opening 53 in the slide plate 42. Then, the cylinders 80, 82 are returned to their fully retracted positions. Once the valve holder 76, containing prosthetic heart valves 10, is properly positioned within the opening 53 in the slide plate 42, the cylinder 86 is actuated to position the slide plate 42 in its test position wherein the prosthetic heart valve 10 is positioned within the test chamber 43. The process is reversed to unload a tested prosthetic heart valve 10 from the test chamber 43 and the slide plate 42.

After the tested heart valve 10 is returned to the storage member 70, the storage member 70 is indexed or moved through use of the stepper motor such that the next prosthetic heart valve 10 to be tested is rotated to the proper position so that it may be removed from and returned to the storage member 70 using the cylinders 80, 82 as described above. Limit switches (not shown) at the travel limits of the various cylinders indicate to the computer 13 that the load-unload operations are complete. Thereafter, the computer 13 can issue instructions causing the storage member 70 to be indexed to the next position.

As to the testing of the valve 10, as an initial matter, it must be confirmed that the prosthetic heart valve 10 is properly positioned within the test chamber 43 prior to performing the proof test or the function test on the prosthetic heart valve 10. The prosthetic heart valve 10 should be positioned such that its leaflets 18, 20, in the open position, extend in the direction indicated by the arrow 29. To confirm the proper positioning of the prosthetic heart valve 10, the valves 30 and 18 are closed, and the valves 28 and 34 are open. The computer 13 causes the pump 24 to supply water at a relatively low rate. The water for the pump 24 flows through the valve 28, into the test chamber 43, through the heart valve 10 and out through the valve 34. The computer 13 monitors the pressure sensor 52 to determine the differential pressure across the prosthetic heart valve 10. If the valve 10 is properly oriented, there should be very little pressure drop across the prosthetic heart valve 10 as the leaflets 18, 20 will be in their open position and the test water will flow freely through the heart valve 10. Conversely, if the prosthetic heart valve 10 is put in backwards, i.e., with the leaflets 18, 20 facing in the direction of arrow 37, then the pressure drop across the prosthetic heart valve 10 will increase very rapidly as the leaflets 18, 20 close due to the direction of the flow of the test water delivered by the pump 24. If the prosthetic heart valve 10 is improperly oriented, an excessive differential pressure (on the order of a few psi) may be detected. Thus, the absence of a large differential pressure across the prosthetic heart valve 10 after the pump 24 stroke indicates that the prosthetic heart valve 10 is properly positioned within the test chamber 43. Of course, similar testing could be accomplished by monitoring the gage pressure (relative to atmospheric) of the test fluid upstream of the prosthetic heart valve 10 instead of the differential pressure across the prosthetic heart valve 10 as described above.

The computer 13 provides detailed tracking and reporting capabilities. Data such as the identification number of the valves 10 being tested and their position within the storage member 70 may be entered into the computer 13 manually, it may be read into the computer 13 using a scanning mechanism, e.g., a bar code reader, or it may be downloaded from other portions of an overall computer system (not shown) associated with a heart valve manufacturing and testing facility. Additionally, the computer 13 is adapted to store the various test data for each of the tested valves 10 on an individual basis. This allows ready retrieval of such data in the event access is needed or desired. Moreover, based upon the data obtained, the computer 13 may calculate/determine the various parameters of interest during the testing of the valves 10, e.g., percent backflow, closing volume, etc.

As set forth above, the apparatus 11 of the present invention may be used to perform a proof test on a prosthetic heart valve 10 in the test chamber 43. As described above, the load/unload assembly 79 will be used to position a prosthetic heart valve 10 (in a heart valve holder 76) in the slide plate 42 and into the test chamber 43. The valve 10 is oriented such that its diameter 10a is approximately vertical. To perform the proof test on the heart valve 25, valves 18 and 30 are opened, and valves 28 and 34 are closed. The two-way solenoid valves 48, 50 are closed to protect the low-range pressure sensors 54, 46, respectively, from the pressures created during the proof test. The pump 24 is actuated to deliver water through the valve 30 to the test chamber 43 and out line 51A through the valve 18 and into the supply tank 14. During this process, data is obtained from the differential pressure sensor 52 as to the differential pressure across the prosthetic heart valve 10. Through use of a PID (proportional-integral-derivative) control loop, the computer 13 controls the operation of the pump 24 based upon the sensed differential pressure across the prosthetic heart valve 10. If the sensed differential pressure across the prosthetic heart valve is below the target value, e.g., 22 psi, the computer 13 will cause the pump 24 to deliver water at a relatively rapid rate. As the differential pressure across the prosthetic heart valve 10 increases or nears the preselected target value, the flow rate of water from the pump 24 is reduced. This process continues until such time as the selected target differential pressure, e.g., 22 psi, is reached. Once the target pressure is reached, the proof test is declared to be successful. If the differential pressure exceeds the maximum allowable pressure, e.g., 30 psi, at any point during the process, the valve is discarded.

After an initial proof test is successfully performed, the prosthetic heart valve 10 is rotated approximately 180° to effectively test the other leaflet pivot/pivot recess connection in its worst case position. This is accomplished through use of the rotating assembly 89. As shown therein, the rotating assembly 89 basically comprises a rack and pinion mechanism that is used to rotate the heart valve holder 76 containing the heart valve 10. More particularly, the rotating assembly 89 comprises a rack 90 coupled to a pneumatic cylinder 92, and a plurality of gear teeth 94 formed on the heart valve holder rotator 94b. The rack 90 is adapted to be moved within an opening 47 in the slide plate portion 42b by actuation of the cylinder 92. Thus, after the completion of the initial proof test, the heart valve holder rotator 94b is rotated approximately 180° by actuating the cylinder 92. After the second proof test is performed, the rack 90 may be returned to its initial position by retraction of the cylinder 92.

Next, after successfully completing the proof test, the functional test of the heart valve 10 is performed. More particularly, a wave form is generated to drive the pump 24 such that test fluid is circulated through the heart valve 10 in a manner than approximately replicates blood flow in a human heart. That is, the pump 24 may be driven such that it replicates a heart pumping at approximately 70 beats per minute using a 35% forward duty cycle. During this process, the valves 30, 18 are closed, and valves 28 and 34 are open. As the pump 24 pushes water through the heart valve 10, the flow meter 36 senses the flow rate of water, the pressure sensor 46 senses the pressure on the outflow side 10c of the heart valve 10, and the pressure sensor 54 senses the differential pressure across the heart valve 10. The pump 24 pushes water through the heart valve 10 in its forward cycle. As the pump 24 retracts, it pulls water through the heart valve 10 causing the leaflets 18, 20 to close. As the heart valve 10 closes, the pump 24 pulls water through the check valve 16, which simulates the operation of a mitral valve. As water flows, the compliance chamber 38 and the pinch valve 40 are used to increase the pressure on the outflow side 10c of the heart valve 10. More particularly, the compliance chamber 38 and pinch valve 40 are used to gradually increase the pressure on the outflow side 10c of the heart valve 10 to approximately 100±3 mm Hg. This pressure is sensed by the pressure sensor 46. To achieve this pressure, the pump 24 may have to go through approximately ten cycles, which may vary depending on the size of the heart valve 10 and its leakage.

Once it is determined that the pressure on the outflow side 10c of the heart valve 10 has stabilized within this 100±3 mm Hg range, the computer 13 captures many, e.g., at least ten, sample pressure and flow rate wave forms. That is, the computer 13 may obtain data from the differential pressure sensor 54 and the flow meter 36. Based upon this data, the computer 13 may calculate an average or mean pressure drop across the heart valve 10 during the forward flow portion of the cycle of the heart valve 10, i.e., during the time when water is flowing through the heart valve 10 in the direction indicated by arrow 29. Additionally, based upon this data, the computer 13 may determine the percent backflow or leakage of the tested heart valve 10. If these parameters fall within some preselected allowable limits, the heart valve 10 is deemed to have passed the functional test.

The present invention may also be used to verify proper calibration of the various test sensors and pumps of the present testing apparatus 11. That is, rather than calibrating the various pressure sensors every day, or after an arbitrarily selected number of tests, the computer 13 may be used to determine if re-calibration is, in fact, required. For example, the verification of the pressure sensors may be accomplished by applying a known pressure to the sensors, and then verifying that the sensors all indicate the known pressure (with allowable tolerances). Similar verification of the accuracy of the pump position feedback apparatus may be performed to insure that accurate pump position feedback data is obtained by the computer 13. Such verification procedures tend to eliminate or reduce errors associated with daily recalibration of the various instruments of the apparatus 11. Moreover, a data file in the computer 13 may be updated and maintained for the various instrumentation of the testing apparatus 11. This data file may contain information with respect to, for example, calibration history and calibration verification history of the various sensors and pumps on the apparatus 11.

The present invention also provides more accurate information as to the flow of test fluid through the heart valve 10 during the functional testing process. That is, the output of the flow meter 36 is provided to the computer 13 during the functional test, and this information is used in calculating the mean pressure drop across the heart valve 10 during the functional test. Thus, the mean pressure drop is determined based upon a measured flow rate of test fluid through the heart valve 10 during the forward flow portion of the pump cycle only. Measurements from the flow meter 36 may also be used to determine if an excessive amount of test fluid is being diverted elsewhere. For example, if the flow rate of test fluid as measured by the flow meter 36 drops below an expected level during the forward flow portion of the pump cycle, this may indicate that the check valve 16 has become worn and is in need of replacement.

The present invention is generally directed to an apparatus for testing prosthetic heart valves, and methods of using same. In one illustrative example, the testing apparatus comprises a test chamber and a slide plate that is slidingly and sealingly coupled to the test chamber, the slide plate having an opening formed therein that is adapted to receive a prosthetic heart valve to be tested in the test chamber. The apparatus further comprises a storage member containing a plurality of prosthetic heart valves to be tested in the test chamber, and a load/unload means for transferring at least one of the heart valves in the storage member between the storage member and the slide plate. In further embodiments, the load/unload means is comprised of first and second pneumatic cylinders that are adapted, when actuated, to remove a heart valve from the storage member and position it in the slide plate. In further embodiments, a third pneumatic cylinder is coupled to the slide plate. When actuated, the third cylinder moves the slide plate relative to the test chamber to thereby position a valve in the chamber for subsequent testing.

In one illustrative embodiment, one method disclosed herein comprises providing a prosthetic heart valve testing apparatus, the apparatus comprised of a test chamber and a storage member, the storage member having a plurality of prosthetic heart valves stored therein, positioning the storage member in a first position, moving a first heart valve from the storage member in the first position to the test chamber, performing at least one test on the first heart valve in the test chamber, and returning the first heart valve from the test chamber to the storage member. The method further comprises moving the storage member to a second position to position a second of the plurality of heart valves for removal from the storage member, moving the second heart valve from the storage member to the test chamber, performing at least one test on the second heart valve in the test chamber, and returning the second heart valve to the storage member.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A prosthetic heart valve testing apparatus, comprising:
a test chamber;
a slide plate slidingly coupled to said test chamber, said slide plate having an opening formed therein that is adapted to receive a prosthetic heart valve to be tested in said test chamber;
a storage member containing a plurality of prosthetic heart valves to be tested in said test chamber; and
a load/unload means for transferring at least one of said heart valves in said storage member between said storage member and said slide plate.

2. The apparatus of claim 1, further comprising a differential pressure sensor coupled to said test chamber, said differential pressure sensor adapted to sense a pressure differential across a prosthetic heart valve during a test performed in said test chamber.

3. The apparatus of claim 1, further comprising a pump for circulating a test fluid through said test chamber.

4. The apparatus of claim 1, further comprising a compliance chamber and a pinch valve in fluid communication with said test chamber.

5. The apparatus of claim 1, wherein said test chamber is comprised of an acrylic tube.

6. The apparatus of claim 1, wherein said slide plate is comprised of stainless steel.

7. The apparatus of claim 1, wherein said slide plate is sealingly coupled to said test chamber by a plurality of O-rings.

8. The apparatus of claim 1, further comprising a stepper motor coupled to said storage member, said stepper motor adapted to index said storage member from a first position to a second position.

9. The apparatus of claim 1, wherein said load/unload means comprises first and second cylinders, each of which have end portions that are adapted to engage a heart valve holder positioned in an opening in said storage member, said heart valve holder having a prosthetic heart valve positioned therein.

10. The apparatus of claim 1, further comprising a means for rotating said heart valve positioned in said slide plate.

11. The apparatus of claim 10, wherein said means for rotating said heart valve comprises:
a rack;
a plurality of gears operatively coupled to a heart valve holder having said heart valve positioned therein; and
a cylinder coupled to said rack.

12. The apparatus of claim 1, wherein said storage member is a disc having a plurality of openings formed therein, each of which is adapted to have a prosthetic heart valve positioned therein.

13. The apparatus of claim 1, further comprising a cylinder coupled to said slide plate that is adapted to move said slide plate relative to said test chamber.

14. A prosthetic heart valve testing apparatus, comprising:
a test chamber;
a slide plate slidingly coupled to said test chamber, said slide plate having an opening formed therein that is adapted to receive a prosthetic heart valve to be tested in said test chamber;
a storage member containing a plurality of prosthetic heart valves to be tested in said test chamber;
a load/unload means for transferring at least one of said heart valves in said storage member between said storage member and said slide plate;
a means for moving said slide plate relative to said test chamber to allow positioning of a prosthetic heart valve in said test chamber; and
a means for rotating a heart valve positioned in said slide plate.

15. The apparatus of claim 14, further comprising a differential pressure sensor coupled to said test chamber, said differential pressure sensor adapted to sense a pressure differential across a prosthetic heart valve during a test performed in said test chamber.

16. The apparatus of claim 14, further comprising a pump for circulating a test fluid through said test chamber.

17. The apparatus of claim 14, further comprising a compliance chamber and a pinch valve in fluid communication with said test chamber.

18. The apparatus of claim 14, wherein said test chamber is comprised of an acrylic tube.

19. The apparatus of claim 14, wherein said slide plate is comprised of stainless steel.

20. The apparatus of claim 14, wherein said slide plate is sealingly coupled to said test chamber by a plurality of O-rings.

21. The apparatus of claim 14, further comprising a stepper motor coupled to said storage member, said stepper motor adapted to index said storage member from a first position to a second position.

22. The apparatus of claim 14, wherein said load/unload means comprises first and second cylinders, each of which have end portions that are adapted to engage a heart valve holder positioned in an opening in said storage member, said heart valve holder having a prosthetic heart valve positioned therein.

23. The apparatus of claim 14, wherein said means for rotating said heart valve comprises:
a rack;
a plurality of gears coupled to a heart valve holder having said heart valve positioned therein; and
a cylinder coupled to said rack.

24. The apparatus of claim 14, wherein said storage member is a disc having a plurality of openings formed therein, each of which is adapted to have a prosthetic heart valve positioned therein.

25. The apparatus of claim 14, wherein said means for moving said slide plate relative to said test chamber comprises a cylinder coupled to said side plate.

26. A prosthetic heart valve testing apparatus, comprising:
a test chamber;
a slide plate slidingly coupled to said test chamber, said slide plate having an opening formed therein that is adapted to receive a prosthetic heart valve to be tested in said test chamber;
a storage member containing a plurality of prosthetic heart valves to be tested in said test chamber;
first and second cylinders, each of which have end portions that are adapted to engage a heart valve holder positioned in an opening in said storage member, said heart valve holder having a prosthetic heart valve positioned therein, said first and second cylinders further adapted to remove said heart valve holder and heart valve from said storage member and position said heart valve holder and heart valve in an opening in said slide plate; and
a third cylinder coupled to said slide plate, said third cylinder adapted to move said slide plate relative to said test chamber to thereby position said heart valve in said slide plate in said test chamber.

27. The apparatus of claim 26, further comprising a differential pressure sensor coupled to said test chamber, said differential pressure sensor adapted to sense a pressure differential across a prosthetic heart valve during a test performed in said test chamber.

28. The apparatus of claim 26, further comprising a pump for circulating a test fluid through said test chamber.

29. The apparatus of claim 26, further comprising a compliance chamber and a pinch valve in fluid communication with said test chamber.

30. The apparatus of claim 26, wherein said test chamber is comprised of an acrylic tube.

31. The apparatus of claim 26, wherein said slide plate is comprised of stainless steel.

32. The apparatus of claim 26, wherein said slide plate is sealingly coupled to said test chamber by a plurality of O-rings.

33. The apparatus of claim 26, further comprising a stepper motor coupled to said storage member, said stepper motor adapted to index said storage member from a first position to a second position.

34. The apparatus of claim 26, further comprising a means for rotating said heart valve positioned in said slide plate.

35. The apparatus of claim 34, wherein said means for rotating said heart valve comprises:
a rack;
a plurality of gears coupled to a heart valve holder having said heart valve positioned therein; and
a cylinder coupled to said rack.

36. The apparatus of claim 26, wherein said storage member is a disc having a plurality of openings formed therein, each of which is adapted to have a prosthetic heart valve positioned therein.

37. A heart valve testing apparatus, comprising:
a test chamber, said test chamber having a heart valve positioned therein for testing;
a compliance chamber and a pinch valve in fluid communication with a portion of said chamber on an outflow side of said heart valve;
a pump for circulating a test fluid through said test chamber, said heart valve, said compliance chamber and said pinch valve;
a computer for controlling said pinch valve to regulate the flow of said test fluid through said pinch valve to thereby assist in controlling a pressure in said test chamber on said outflow side of said heart valve.

38. The apparatus of claim 37, further comprising a supply tank downstream of and in fluid communication with said pinch valve, said supply tank having a level sensor that is controlled by said computer to control the level of test fluid in said supply tank.

39. The apparatus of claim 37, wherein said compliance chamber is comprised of at least two air-filled diaphragms.

40. The apparatus of claim 37, wherein said pump is a reciprocating pump.

41. The apparatus of claim 37, wherein said pinch valve is a lead screw driven clamping device.

42. The apparatus of claim 37, wherein said pinch valve is actuated by a stepper motor.

43. A method of testing prosthetic heart valves, comprising:
providing a prosthetic heart valve testing apparatus, said apparatus comprised of a test chamber and a storage member, said storage member having a plurality of prosthetic heart valves stored therein;
positioning said storage member in a first position;
moving a first heart valve from said storage member in said first position to said test chamber;
performing at least one test on said first heart valve in said test chamber;
returning said first heart valve from said test chamber to said storage member;
moving said storage member to a second position to position a second of said plurality of heart valves for removal from said storage member;
moving said second heart valve from said storage member to said test chamber;
performing at least one test on said second heart valve in said test chamber; and
returning said second heart valve to said storage member.

44. The method of claim 43, wherein moving a first heart valve from said storage member in said first position to said test chamber comprises:
actuating a first and a second cylinder to remove said first heart valve from said storage member and position said first heart valve in a slide plate of said apparatus that is slidingly coupled to said test chamber; and
actuating a third cylinder to move said slide plate having said first heart valve positioned therein into a test position in said test chamber.

45. The method of claim 43, wherein performing at least one test on said first heart valve in said test chamber comprises performing at least one of a proof test and a functional test on said first heart valve in said test chamber.

46. The method of claim 44, wherein returning said first heart valve from said test chamber to said storage member comprises:
actuating said third cylinder to move said slide plate having said first heart valve positioned therein to a load/unload position proximate said storage member; and
actuating said first and second cylinders to remove said first heart valve from said slide plate and position said first heart valve in said storage member.

47. The method of claim 43, wherein moving said storage member to a second position to position a second of said plurality of heart valves for removal from said storage member comprises actuating a stepper motor coupled to said storage member to move said storage member to a second position so as to position a second of said plurality of heart valves for removal from said storage member.

48. The method of claim 47, wherein moving a second heart valve from said storage member to said test chamber comprises:
actuating said first and said second cylinders to remove said second heart valve from said storage member and position said second heart valve in a slide plate of said apparatus that is slidingly coupled to said test chamber; and
actuating a third cylinder to move said slide plate having said second heart valve positioned therein into a test position in said test chamber.

49. The method of claim 43, wherein performing at least one test on said second heart valve in said test chamber comprises performing at least one of a proof test and a functional test on said second heart valve in said test chamber.

50. The method of claim 48, wherein returning said second heart valve from said test chamber to said storage member comprises:
actuating said third cylinder to move said slide plate having said second heart valve positioned therein to said load/unload position proximate said storage member; and
actuating said first and second cylinders to remove said second heart valve from said slide plate and position said second heart valve in said storage member.
